(19) United States
(12) Patent Application Publication
(10) Pub. No.: US 2008/0307200 A1
(43) Pub. Date: Dec. 11, 2008

(54) Method of burning in extended display identification data without using a computer

(75) Inventor: Shih-Hua Tseng, Taipei (TW)

Correspondence Address: BACON & THOMAS, PLLC, 625 SLATERS LANE, FOURTH FLOOR, ALEXANDRIA, VA, 22314-1176, US

(73) Assignee: Tatung Company, Taipei (TW)

(21) Appl. No.: 12/003,534

(22) Filed: Dec. 28, 2007

(30) Foreign Application Priority Data
Jun. 8, 2007 (TW) 096120882

(51) Int. Cl. G06F 15/00

(52) U.S. Cl. 712/37; 712/E09.001

(57) ABSTRACT

The present invention relates to a method of burning in extended display identification data (EDID) without using a computer, wherein an EDID burning device is connected to an input device via an input device interface, a product barcode labeled on a to-be-burned display device is inputted for obtaining product data which is then respectively merged into a plurality of EDID, and then an EDID burning operation is performed to the to-be-burned display device via a VGA video connection interface, a DVI video connection interface and a HDMI video connection interface at the same time. Therefore, the present invention could be departed from a computer structure and could directly burn in the EDID. That is, the present invention could burn in more than one connection interface at a time during an independent operation, thereby saving cost and time.

### BACKGROUND OF THE INVENTION

1. Field of the Invention

The present invention relates to a method of burning in extended display identification data, and more particularly, to a method of burning in extended display identification data without using a computer.

2. Description of Related Art

With the popularity of computer technology, the plug and play function becomes an essential function of computer peripheral equipment. As to a display device, the video electronics standard association (VESA) is responsible for promoting and developing important display device and display interface standards, so as to make sure its commonality. Extended display identification data (EDID) standard is one of the standard data formats established by VESA. EDID includes basic data of a display device, such as: manufacturer information, maximum image size, color feature, usage frequency limitation, and etc. The EDID is stored in a display device and used for communicating with a host, thereby achieving the plug and play function.

In a conventional technique, the display device manufacturer uses a personal computer (PC) structure as its operation way. That is, writing EDID into a non-erasable memory via a VGA interface or DVI interface of the display device. For example, as to a display device with a VGA interface, the PC writes the EDID into the display device via the VGA interface.

FIG. 1A and FIG. 1B illustrate schematic drawings of conventional EDID burning operations and methods. As shown in both FIG. 1A and FIG. 1B, a computer device 193 is connected to a display device 191 by means of a transmission line 194, and performs an EDID burning operation to the display device 191 via a scanner 192. The only difference between FIG. 1A and FIG. 1B is that, in FIG. 1A, the computer device 193 has to use a graphics card with a VGA interface to perform the burning operation to a VGA interface 1911 of the display device 191. However, under such connected burning way, the graphics card of the computer device 193 must have a VESA BIOS extensions (VBE) function, otherwise there would always result in a compatibility-not-supported situation.

Further, the difference in FIG. 1B is that an interface converting device 195 is added for not only overcoming the above VBE compatibility problem, but also performing the burning operation to a DVI interface 1912 of the display device, such that the VGA interface of the computer could be adapted to different interfaces of the display device 191 through conversion.

With regard to another conventional burning operation and method as shown in FIG. 2, a computer device 293 comprises a printer port 2931 or other port such as RS232, USB, and so on. In the conventional burning way, the printer port 2931 or other port is connected to a DVI interface 2911 of a display device 291 via an interface converting device 295, so as to write EDID into the display device 291. Moreover, an interface converting device 295 must be added to a transmission line 294 between the aforementioned printer port 2931 and the DVI interface 2911 in advance, and then a printer 292 could be used to perform the burning operation to the display device 291.

However, there are a lot of shortcomings in the abovementioned conventional EDID burning operation ways, such as: (1) only burning one video connection interface at a time; (2) a PC and an additional video signal resource are required during the burning operation; (3) a PC graphics card has to be a specific graphics card which supports the VBE function, otherwise a printer port or other port with an additional interface converting device is required; (4) the burning operation could only be performed at a fixed location; (5) a monitor is required for observing the operation result, however, the operator would probably encounter a determination inconvenience situation due to his/her angle of view.

Therefore, it is desirable to provide a method of burning extended display identification data without using a computer to mitigate and/or obviate the aforementioned problems.

### SUMMARY OF THE INVENTION

In order to solve the abovementioned problems, the present invention provides a method of burning in extended display identification data (EDID) without using a computer, which comprises the following steps: step (A) provides a to-be-burned display device which is labeled with a product barcode; step (B) provides an EDID burning device, which is connected to an input device and comprises a plurality of output video connection interfaces, wherein the plurality of output video connection interfaces are all connected to the to-be-burned display device, the memory unit stores a plurality of EDID and system data corresponding to the plurality of output video connection interfaces; step (C) utilizes the input device to input the product barcode on the to-be-burned display device to obtain product data; and step (D) respectively merges the product data into the plurality of EDID, and burns both the merged data and the system data into the to-be-burned display device. Therefore, the present invention provides a method of burning EDID without using a computer, which is departed from a computer structure and could directly burned the EDID without adding a video signal source. That is, the present invention could burn in more than one connection interface at a time during an independent operation without being mounted at a fixed location, thereby saving cost and time, solving the problem that a PC graphics card must be a specific graphics card which supports the VBE function, and also solving the problem that the operator encounters a determination inconvenience situation due to his/her angle of view.

According to the above description, in the method of burning in EDID without using a computer of the present invention, the EDID burning device in step (B) further comprises an expansion interface, an input device interface and a microcontroller, wherein the microcontroller is electronically connected to the plurality of output video connection interfaces, the memory unit, the input device interface and the expansion interface.

According to the above description, in the method of burning in EDID without using a computer of the present invention, the EDID burning device in step (B) further comprises a display unit, which is connected to the expansion interface, used for displaying the product data after utilizing the input device to input the product barcode on the to-be-burned display device to obtain the product data in step (C). The expansion interface is connected to the burning device by collaborating with a multiplexer. When a system detects a connection with such expansion interface, the system is automatically transformed from a video connection interface to download high-bandwidth digital content protection (HDCP) data. Preferably, eight or even more batches of data could be burned at a time.

According to the above description, in the method of burning in EDID without using a computer of the present invention, the EDID burning device in step (B) further comprises an external computer connection interface electronically connected to the microcontroller. Moreover, after performing step (B1) to determine whether the plurality of EDID are correct, step (B2) could be performed to connect to the external computer connection and an external computer to download data for updating the plurality of EDID of the memory unit, and step (C) would be performed. On the contrary, in step (B1), if the plurality of EDID are determined to be correct, step (C) could be directly performed.

According to the above description, in the method of burning in EDID without using a computer of the present invention, the plurality of output video connection interfaces of the EDID burning device of step (B) comprise a VGA video connection interface, a DVI video connection interface and a HDMI video connection interface.

According to the above description, in the method of burning in EDID without using a computer of the present invention, step (C1) is further performed before step (D) to check connection statuses of the VGA video connection interface, the DVI video connection interface and the HDMI video connection interface, and automatically determine whether to record the corresponding video connection interface according to the connection statuses.

According to the above description, in the method of burning in EDID without using a computer of the present invention, the memory unit in step (B) further stores counter data, such that step (F) is further performed to accumulate one record in the counter data of the memory unit after step (E).

### BRIEF DESCRIPTION OF THE DRAWINGS

FIGS. 1A and 1B illustrate schematic drawings of conventional EDID burning operations and methods.

FIG. 2 illustrates a schematic drawing of another conventional EDID burning operation and method.

FIG. 3 illustrates a schematic drawing of an EDID burning operation and method of one preferred embodiment according to the present invention.

FIG. 4 illustrates a schematic drawing of a product barcode of one preferred embodiment according to the present invention.

FIGS. 5A˜5E are flowcharts of burning EDID of one preferred embodiment according to the present invention.

FIG. 6 illustrates a schematic drawing of data merge of one preferred embodiment according to the present invention.

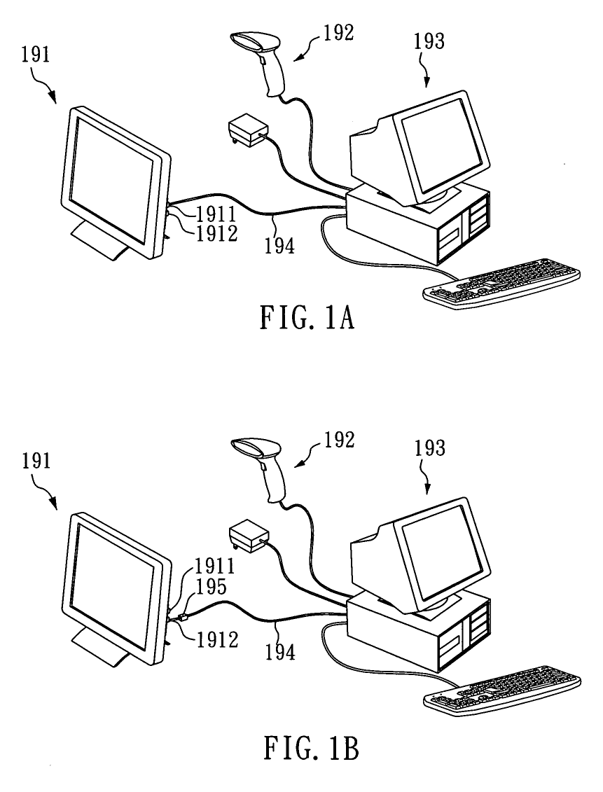

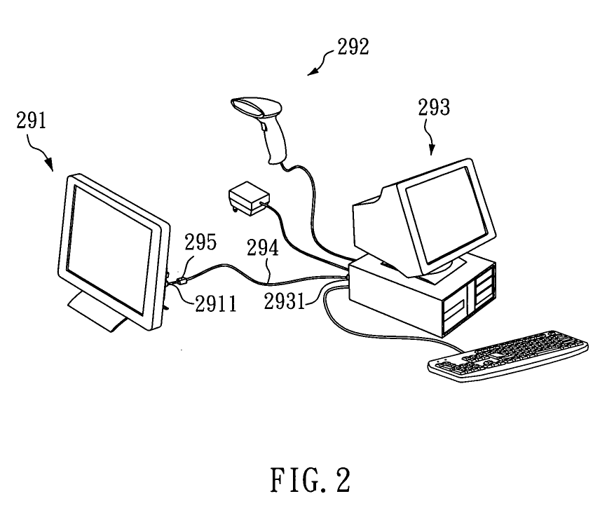

### DETAILED DESCRIPTION OF THE PREFERRED EMBODIMENT

Below please find specific embodiments to explain the implementation of the present invention, such that a person skilled in the art could easily understand the advantage and effect of the present invention according to the disclosure of this specification.

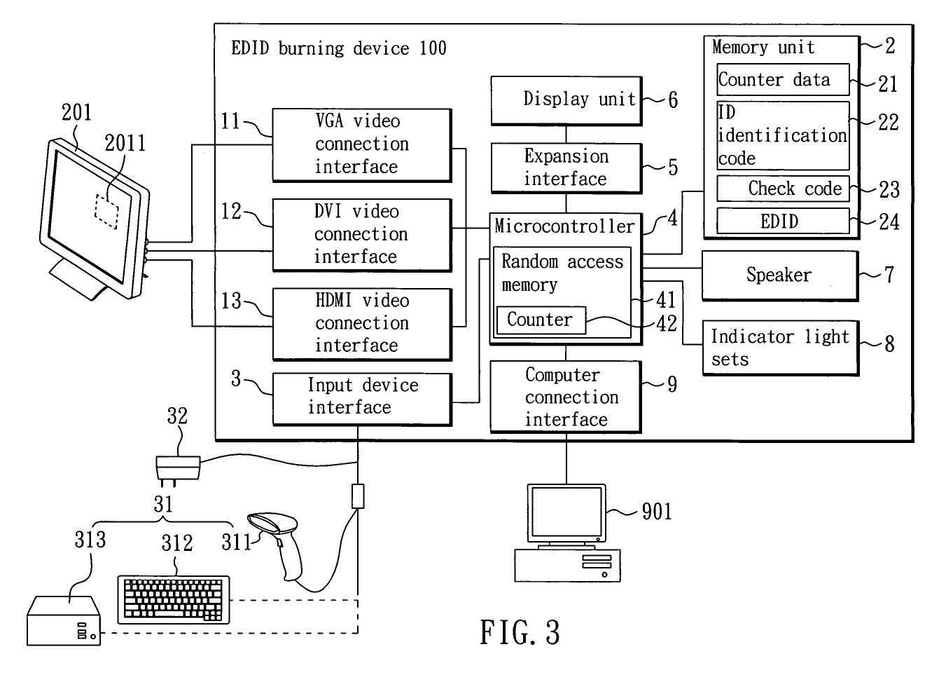

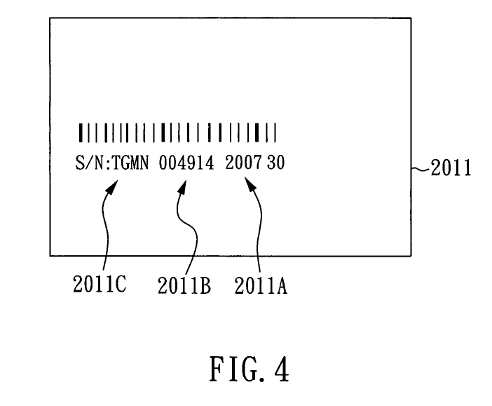

Please refer to FIG. 3 first. As shown in FIG. 3, in this embodiment, an EDID burning device 100 is connected to an input device 31 (preferably a barcode scanner 311, a keyboard 312, or a radio frequency identification (RFID) device 313) though an input device interface 3, so as to input a product barcode 2011 (as shown in FIG. 4, the product barcode 2011 includes a manufacturing date 2011A, a product serial number 2011B and a product type 2011C) labeled on a to-be-burned display device 201, and then process a burning operation to the to-be-burned display device 201 through a VGA video connection interface 11, a DVI video connection interface 12 and a HDMI video connection interface 13 of output ports. Further, the EDID burning device 100 of this embodiment could selectively use a battery to supply power as a direct current working voltage source, or set a power input unit 32 in the input device 31 for supplying power. The power input unit 32 is a transformer, which supplies 9˜12 direct current voltage after connecting to general alternating current. Further, a power input device 2012 of the to-be-burned display device 201 could also supply power. Moreover, the EDID burning device 100 has an external computer connection interface 9, used for connecting to an external computer 901, thereby downloading data.

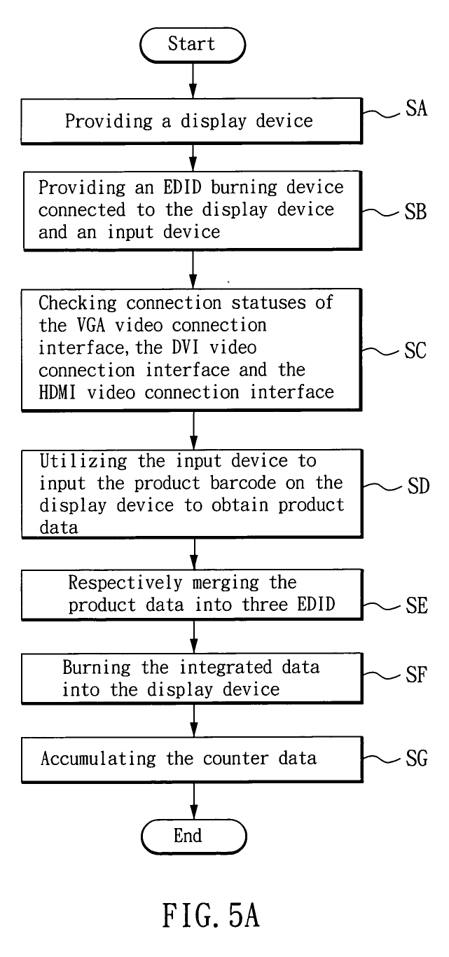

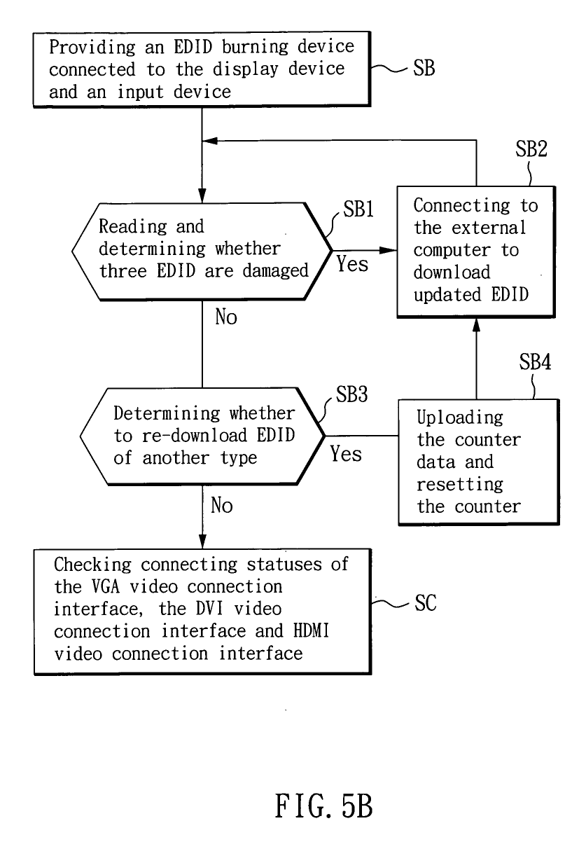

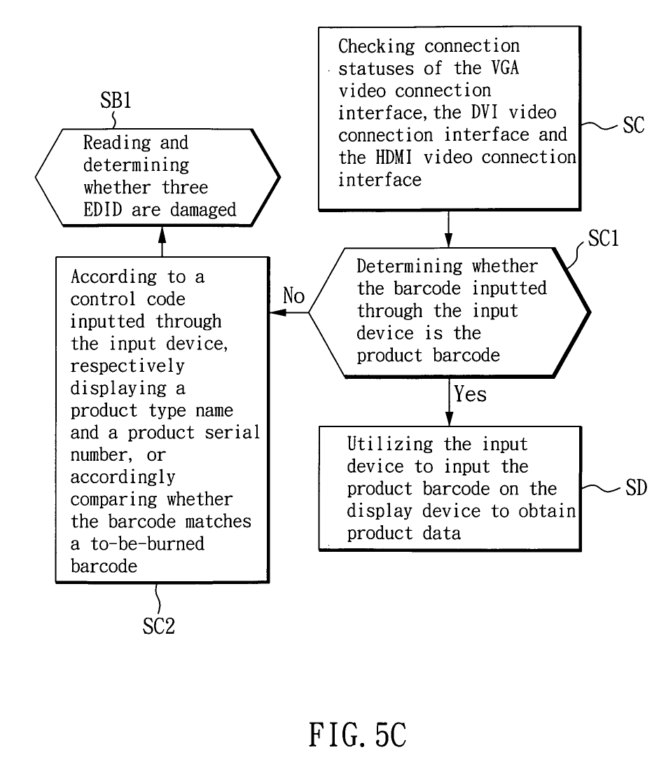

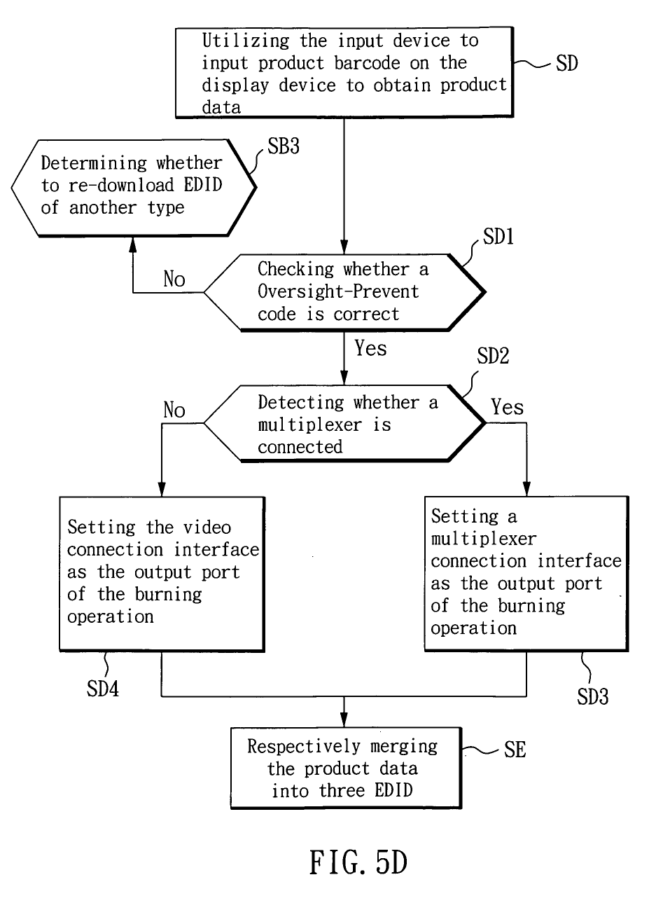

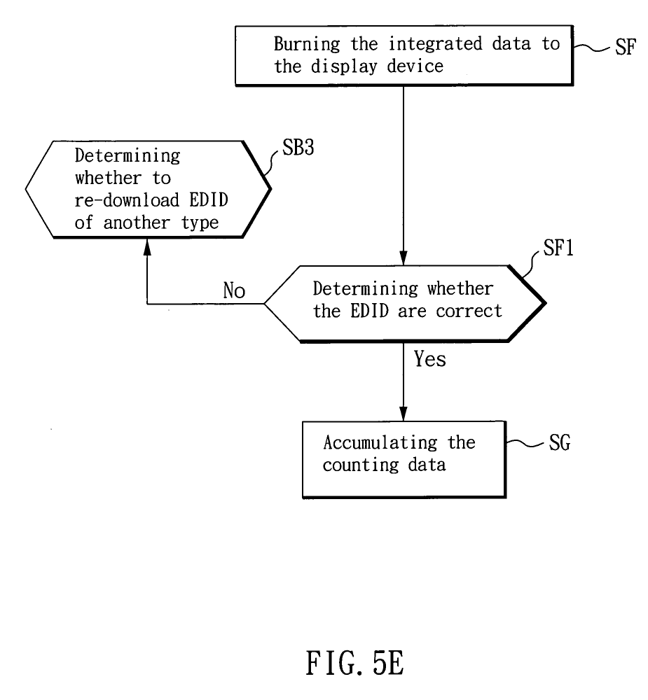

FIG. 5A illustrates a flowchart of one embodiment according to the present invention. Please also refer to FIG. 3 and FIG. 4 for a detailed description.

Firstly, the method provides a to-be-burned display device 201 labeled with a product barcode 2011 (step SA). As shown in FIG. 4, the product barcode 2011 is an independent item of the to-be-burned display device 201, and includes a manufacturing date 2011A, a product serial number 2011B and a product type 2011C. In this embodiment, the EDID burning device 100 could process the burning operation to a to-be-burned display device 201 of any brand only when the product barcode 2011 is transformed to an analytic format of the EDID burning device 100.

Then, the method provides an EDID burning device 100 (step SB), which comprises three output video connection interfaces (in this embodiment, the video connection interfaces are a VGA video connection interface 11, a DVI video connection interface 12 and a HDMI video connection interface 13), a memory unit 2, an input device interface 3, a microcontroller 4, an expansion interface 5, a display unit 6, a speaker 7, an indicator light sets 8 and an external computer connection interface 9. The memory unit 2 stores EDID 24 corresponding to the VGA video connection interface 11, the DVI video connection interface 12 and the HDMI video connection interface 13, as well as stores system data SYS. The system data could further include counter data 21, ID identification code 22, check code 23, system parameters, type data, and etc. The microcontroller 4 is either directly or indirectly electronically connected to all of the above elements. Further, the input device interface 3, the VGA video connection interface 11, the DVI video connection interface 12 and the HDMI video connection interface 13 could be respectively connected to the input device 31 and the to-be-burned display device 201. In this embodiment, the memory unit 2 stores EDID 24, wherein EDID1 is allocated to VGA, EDID2 is allocated to DVI, and EDID3 is allocated to HDMI. Those three EDID of the present invention are just an example for an easier explanation rather than limiting the above disclosure of the present invention. The memory unit 2 is an electrically erasable programmable read-only memory (EEPROM), and the microcontroller 4 is a standard 8051 single chip, which includes a random access memory (RAM) 41. The expansion interface 5 could be connected to the EDID burning device 100 by collaborating with a multiplexer (not shown in figures). When a system detects a connection with such expansion interface 5, the system is automatically transformed from a video connection interface to download high-bandwidth digital content protection (HDCP) data. Preferably, eight or even more batches of data could be burned at a time.

FIG. 5B further shows a control flow to make sure that the EDID 24 stored in the memory 2 correspond to the VGA video connection interface 11, the DVI video connection interface 12 and the HDMI video connection interface 13 of the to-be-burned display device 201. Please note that three EDID refer to memory spaces of EDID1, EDID2 and EDID3, wherein VGA corresponds to EDID1, DVI corresponds to EDID2, and HDMI corresponds to EDID3. The method firstly reads and determines whether three EDID are damaged (step SB1). If so, step SB2 is performed for connecting to the external computer 901 via the external computer connection interface 9, so as to download data to update three EDID of the memory unit 2, and then return to step SB1. Otherwise, step SB3 is performed for determining whether to re-download EDID of another type. If step SB3 determines to re-download the EDID of another type, step SB4 is then performed. Step SB4 firstly uploads counting value data, resets the counter data 21, and then performs step SB2. If step SB3 determines not to re-download the EDID of another type, it would check connection statuses between the to-be-burned display device 201 and the VGA video connection interface 11, the DVI video connection interface 12 and the HDMI video connection interface 13 one by one before starting the burning operation (step SC), so as to automatically determine whether to burn in the corresponding video connection interface based on the connection status.

FIG. 5C further shows a control flow to perform the input of the product barcode. After step SC, step SC1 is further included for inputting a barcode to the input device to determine whether the inputted barcode is the product barcode. If so, step SD is performed; otherwise step SC2 is performed. In step SC2, according to a control code inputted through the input device 31, step SC2 respectively displays a product type name and a product serial number, or accordingly compares whether the barcode matches a to-be-burned barcode, so as to avoid an incorrect burning operation due to using EDID with an incorrect type, and then return to step SB1.

When both the to-be-burned display device 201 and the EDID burning device 100 are all equipped and ready, the input device 31 is immediately utilized to input the product barcode 2011 on the to-be-burned display device 201 to obtain product data, and then the display unit 6 is utilized to display product information (step SD).

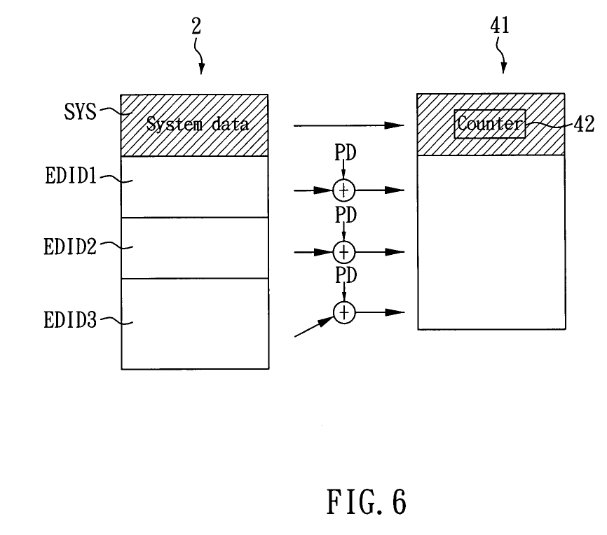

Next, please refer to both FIG. 5D and FIG. 6. The microcontroller 4 of the EDID burning device 100 compares the previously obtained product data PD with the check code 23 of the system data SYS (gray area) of the memory unit 2, so as to perform a Oversight-Prevent check (step SD1). If the product data doesn't match the check code 23, the method returns to step SB3; otherwise the method further determines whether the expansion interface 5 is connected to a multiplexer (step SD2). If so, the method sets a multiplexer connection interface as the output port of the EDID burning device 100 (step SD3); otherwise, the method sets the video connection interface as the output port of the EDID burning device 100 (step SD4). Then, the method respectively merges the product data PD, the EDID 24 of the memory unit 2, i.e. the VGA EDID1, the DVI EDID2 and the HDMI EDID3, along with part of the system data SYS (gray area), and integrates them to the random access memory 41 (step SE). Finally, the method simultaneously burns the integrated data in the random access memory 41 into the to-be-burned display device 201 (step SF). In this embodiment, this is just an example that VGA corresponds to the EDID1 memory space, DVI corresponds to the EDID2 memory space, and HDMI corresponds to the EDID3 memory space. The example is not used to limit the above disclosure of the present invention.

FIG. 5E further shows a control flow to make sure the accuracy of the EDID burning operation. After step SF, the method determines whether three EDID in the to-be-burned display device 201 and that in the memory unit 2 are consistent (step SF1). If so, the method performs step SG; otherwise, the method returns to step SB3 to determine whether to re-download EDID of another type. Step SF1 firstly reads the burned EDID in the display device 201, and then compares the burned EDID with the EDID in the EDID burning device 100, so as to make sure the accuracy of the EDID burned to the display device 201.

Finally, after completing the burning operation, a counter 42 of the microcontroller 4 of the EDID burning device 100 is used to accumulate an EDID burning time, and stores the EDID burning time to the counter data 21 of the memory unit 2 as a reference to charge the user in the future (step SF).

In order to let the user aware of the burning situation during the burning operation, the EDID burning device 100 could display burning state information or send a burning status message via the display unit 6, the speaker 7 and the indicator light sets 8. In this embodiment, the indicator light sets 8 comprise a green LED, a red LED and a yellow LED. For example, if the burning operation is successful, a green light would be emitted through the green LED; otherwise, a red light would be emitted through the red LED. Therefore, even the burning operation is performed under a noisy environment, the user could immediately obtain the burning situation by checking the burning status message sent by the indicator light sets 8. Further, the yellow LED is used to indicate the power strength. If the power is too low, the display unit 6 is also capable of displaying a low power message to remind the user to charge.

According to the above description, the present invention provides a method of burning extended display identification data without using a computer, which is departed from a computer structure and could directly burn in the EDID without adding a video signal source. That is, the present invention could burn in more than one connection interface at a time during an independent operation without being mounted at a fixed location, thereby saving cost and time, solving the problem that a PC graphics card must be a specific graphics card which supports the VBE function, and also solving the problem that the operator encounters a determination inconvenience situation due to his/her angle of view.

Although the present invention has been explained in relation to its preferred embodiment, it is to be understood that many other possible modifications and variations can be made without departing from the spirit and scope of the invention as hereinafter claimed.

What is claimed is:

1. A method of burning in extended display identification data (EDID) without using a computer, comprising:
(A) providing a to-be-burned display device which is labeled with a product barcode;
(B) providing an EDID burning device, which is connected to an input device and comprises a plurality of output video connection interfaces and a memory unit, wherein the plurality of output video connection interfaces are all connected to the to-be-burned display device, the memory unit stores a plurality of EDID and system data corresponding to the plurality of output video connection interfaces;
(C) utilizing the input device to input the product barcode on the to-be-burned display device to obtain product data;
(D) respectively merging the product data into the plurality of EDID; and
(E) burning both the data obtained form step (D) and the system data into the to-be-burned display device.

2. The method as claimed in claim 1, wherein in step (B), the EDID burning device further comprises an expansion interface, an input device interface and a microcontroller, wherein the microcontroller is electronically connected to the plurality of output video connection interfaces, the memory unit, the input device interface and the expansion interface.

3. The method as claimed in claim 2, wherein in step (B), the EDID burning device further comprises a display unit, connected to the expansion interface, used for displaying the product data after utilizing the input device to input the product barcode on the to-be-burned display device to obtain the product data in step (C).

4. The method as claimed in claim 2, wherein in step (B), the expansion interface is connected to the EDID burning device by collaborating with an external multiplexer, when a system detects a connection with the expansion interface, the system is automatically transformed from a video connection interface to download high-bandwidth digital content protection (HDCP) data.

5. The method as claimed in claim 3, wherein during the burning operation in step (E), the display unit could display burning status information.

6. The method as claimed in claim 2, wherein in step (B), the EDID burning device further comprises a speaker, electronically connected to the microcontroller, used for informing a burning status message during the burning operation in step (E).

7. The method as claimed in claim 2, wherein in step (B), the EDID burning device further comprises an indicator light sets, electronically connected to the microcontroller, used for informing a burning status message during the burning operation in step (E).

8. The method as claimed in claim 2, wherein in step (B), the EDID burning device further comprises an external computer connection interface electronically connected to the microcontroller.

9. The method as claimed in claim 8 further comprising the following steps before step (C):
(B1) reading the plurality of EDID and determining whether the EDID are damaged, if so, performing step (B2), otherwise performing step (B3);
(B2) connecting to the external computer connection interface and an external computer to download data for updating the plurality of EDID of the memory unit, and then returning to step (B1); and
(B3) determining whether to re-download EDID of another type, if so, uploading counting value data and resetting the counter data, and executing step (B2).

10. The method as claimed in claim 3, wherein in step (B), the plurality of output video connection interfaces of the EDID burning device comprise a VGA video connection interface, a DVI video connection interface and a HDMI video connection interface.

11. The method as claimed in claim 10 further comprising step (C1) after step (C): checking connection statuses of the VGA video connection interface, the DVI video connection interface and the HDMI video connection interface, and automatically determining whether to burn in the corresponding video connection interface according to the connection statuses.

12. The method as claimed in claim 11 further comprising the following steps after step (C1):
(C2) inputting a barcode to the input device and determining whether the barcode is the product barcode, if so, performing step (D), otherwise performing step (C3); and
(C3) according to a control code inputted through the input device, respectively displaying a product type name and a product serial number, or accordingly comparing whether the barcode matches a to-be-burned barcode, so as to avoid an incorrect burning operation due to using EDID with an incorrect type.

13. The method as claimed in claim 9 further comprising the following step after step (C):
(C4) comparing the previously obtained product data with a check code of the system data of the memory unit to perform a Oversight-Prevent check, if the product data matches the check code, returning to step (B3), otherwise performing step (D).

14. The method as claimed in claim 2, wherein in step (B), the memory unit further stores counter data, such that step (F) accumulates the counter data of the memory unit after step (E).

15. The method as claimed in claim 12 further comprising step (E1) after step (E): checking whether the plurality of EDID in the to-be-burned display device match the EDID in the memory unit, if so, performing step (F), otherwise returning to step (B3).

16. The method as claimed in claim 1, wherein step (D) respectively merges and integrates the product data and the plurality of EDID into a random access memory.

17. The method as claimed in claim 16, wherein the plurality of EDID comprise VGA EDID, DVI EDID and HDMI EDID.
